(19) United States
(12) Patent Application Publication
(10) Pub. No.: US 2008/0010871 A1
(43) Pub. Date: Jan. 17, 2008

(54) PRODUCT DISPLAY SYSTEM AND METHOD

(76) Inventors: Brent D. Holmes, Brentwood, TN (US); Bill G. Collier JR., Old Hickory, TN (US); David B. Holmes, Mobile, AL (US)

Correspondence Address: ADVANTIA LAW GROUP, 9035 SOUTH 1300 EAST, SUITE 200, SANDY, UT, 84094, US

(21) Appl. No.: 11/776,405

(22) Filed: Jul. 11, 2007

Related U.S. Application Data
(63) Continuation-in-part of application No. 11/234,791, filed on Sep. 23, 2005.

(51) Int. Cl. G09F 9/35

(52) U.S. Cl. 40/1; 40/448; 40/455; 40/463; 40/465

(57) ABSTRACT

A product display system and method. The system includes: a housing configured to contain a product; a power module that provides electrical power; an electronic paper display module that visually displays images; an operating module that controls image displays; a memory module that stores images; an activation module that selectably restricts power consumption; a transceiver module that transmits and receives signals, and alters an image display upon receipt of a signal; a remote control module that enables a user to selectably transmit a signal; and a signal converting module that alters a state of a signal. The method steps include: providing a product; coupling a product display system to the product; subscribing to at least one of a plurality of image content providers; receiving a wireless signal from an image content provider; converting a signal to an image; storing an image; displaying an image; and deleting a displayed image.

### CROSS-REFERENCE TO RELATED APPLICATIONS

This application claims priority to the pending nonprovisional patent application, to which this application is a continuation-in-part thereof, “PRODUCT DISPLAY SYSTEM AND CONTAINER”, Ser. No. 11/234,791, filed Sep. 23, 2005, which is incorporated by reference herein.

### BACKGROUND OF THE INVENTION

1. Field of the Invention

The present invention relates to containers, specifically to containers and product display systems having changing and/or changeable displays and a method for generating and/or changing the same.

2. Description of the Related Art

In a retail environment, the ability to stand out above competitors is vital to successful sales. Various methods, systems and devices are used to increase the visibility of products. Such product displays include signs, display orientation, lights, bright colors, and 3-dimensional displays associated with products. Some examples of references related to the present invention are described below, and the supported teachings of each are incorporated by reference herein.

US Patent Application Publication No. 2004/0246684, by Karaki, discloses a sheet computer, wearable computer, display device, fabrication methods, and electronic devices thereof that eliminate the drawback in operational speed caused by clock delays of a system clock and that is capable of high speed operation. In order to achieve this object, a display circuit and peripheral circuits connected to the display circuit are fabricated on the same substratum and the peripheral circuits constitute an asynchronous system without global clocking. In the asynchronous system, processes constituting minimum function circuits perform mutual handshaking by channels and drive events actively or passively. The asynchronous system does not use global clocking and it is therefore possible to implement lower power consumption and a higher operational speed.

U.S. Patent Application Publication No. 2005/0041091, by Sawyer, discloses a drive capable of printing a label on a unit of optical media. The drive includes a first head optically communicating with the media on a first side and a second label printing head for applying a visual label associated with the unit of optical media on a second side while the media is in an operational position. The first head includes an optical read-only head or read-write head. The second label printing head includes a fixed or movable print head, thermal, ink jet, or laser print head. The second head can communicate through electrical contacts or a wireless interface with a circular film having addressable elements capable of being addressed and providing a visual display via liquid crystal elements.

US Patent Application Publication No. 2005/0246621, by Ogawa et al., discloses an electronic paper display system capable of communicating in non-contact with an electronic paper by transfer apparatus and managing information by use of an electronic paper high in illegibility and portability as a medium of information display. An electronic paper display system that communication is made with display apparatus having an electronic paper and wireless tag from transfer apparatus capable of accessing a PC or a network, to perform a personal identification, based on which display information is transferred. Meanwhile, by transfer apparatuses arranged in plurality in a space, the electronic paper is detected to manage information.

US Patent Application Publication No. 2006/0017659, by Ogawa et al., discloses an improved electronic paper display system capable of communicating in non-contact with an electronic paper by transfer apparatus and managing information by use of an electronic paper high in illegibility and portability as a medium of information display. An electronic paper display system that communication is made with display apparatus having an electronic paper and wireless tag from transfer apparatus capable of accessing a PC or a network, to perform a personal identification, based on which display information is transferred. Meanwhile, by transfer apparatuses arranged in plurality in a space, the electronic paper is detected to manage information.

US Patent Application Publication No. 2007/0061337, by Saito et al., discloses an electronic paper system including: a document data storage which stores document data; an electronic paper having a display that displays and retains a document image based on the document data in a no-power state and a memory that readably and writably stores link information enabling access to the document data stored in the document data storage; and a control apparatus which, when storing the document data in the document data storage, controls a method of storing the document data in the document data storage in accordance with a preset condition, and controls the storage of the link information in the memory of the electronic paper in response to the method thus controlled.

U.S. Pat. No. 6,333,754, issued to Oba et al., discloses an image displaying apparatus, a method for displaying an image and an image displaying medium can provide an image of a large viewing angle and high stability of the particles upon repeated use. On electronic paper containing a display substrate formed of a hole transporting film, a non-display substrate formed of a film having a two-layer structure containing a charge transporting film having formed thereon an electrode layer having a thickness of about 50 mm, and conductive black particles and insulating white particles contained therebetween, an electric field is generated at a position corresponding to image data by a recording head, so as to move the black particles attached to the entire surface of the display substrate toward the non-display substrate, whereby an image of contrast of black and white is formed on the display substrate.

However, some problems associated with such methods and devices include: inefficient power consumption; displays that are too visually aggressive once an initial glance is caught; an inability to adapt to various products; an inability to generalize to multiple products; an inability to enable a user to selectably change images or media on product displays through a remote means; and/or failure to direct attention and/or maintain attention directly to a product and/or a container.

What is needed is a product display system and/or a method that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available containers. Accordingly, the present invention has been developed to provide a product display system and/or a method for changing a display.

In one embodiment there is a product display system that may include a housing for containing a container and/or a product and/or for holding a product; a power module that may be coupled to the housing and/or configured to provide electrical power; a display module that may be coupled to the housing, electrically coupled to the power source or module, and/or configured to visually display a first image and/or a second image; a processor in electrical communication with the display module and/or configured to control display of the first and/or second images; and/or a memory module in communication with the display module and/or configured to store information regarding the first and second images. The display module may include electronic paper.

The product display system may also include an activation module in electrical communication with at least one of the group consisting of the display module, the processor, and the power source or module, wherein the activation module is configured to selectably restrict power consumption from the power module. The activation module may include a light detector or sensor. The activation module may further permit power consumption when light is detected and/or may restrict power consumption when light is not detected. The activation module may also include a solar cell or module electrically coupled to the power module and/or configured to provide power to the power module when exposed to light. The product display system may further include an interface module that may be a tab that may be in removable communication with the memory module. The product display system may further include a second display module coupled to the housing, electrically coupled to the power source, and/or configured to visually display a third image and/or a fourth image. The display module may include a protective coating disposed over the display module.

In another embodiment, there may be a product display system for attaching to a product. The product display system may include a power module configured to provide power; a display module in electrical communication with the power module and/or configured to selectably display visual information; an operating module in communication with the display module and/or configured to control the display module; and/or a coupling device coupled to each of the power module, the display module, and/or the operating module and/or configured to couple the product display system to the product.

The coupling device may be indirectly coupled to the power module. The coupling device may include an adhesive layer coupled to the display module; and/or a release layer coupled to the adhesive layer and/or configured to be removed without substantially removing the adhesive layer thereby exposing the adhesive layer. The product display system may also include a backlight module disposed behind the display module and configured to emit light through the display module, and/or a front light module that may emit light on the front of the display module. The product display system may further include an interface module removably coupled to the operating module and/or in communication therewith. The interface module may include a perforated tab extending from the operating module. The power module may include a sheet battery. In other embodiments, the power module may include a dry cell battery.

In still another embodiment, the product display system may include a power module configured to provide power; a display module in power communication with the power module and/or configured to selectably display visual information; an operating module in communication with the display module and/or configured to control the display module; and/or a housing module coupled to the display module and/or configured to contain the product.

The product display system may further include a recharging module in electrical communication with the power module and/or configured to supply power to the power module. The housing module may be substantially ensconced by the display module. The display module may include a protective sleeve and/or cover. The product display system may also include an interface module removably coupled to the operating module and/or in communication therewith. The display module may include electronic paper.

One embodiment of the product display may include a transceiver module in communication with at least one of the group consisting of: the power module, the activation module, the operating module, and/or the display module. The transceiver module may transmit and/or receive a signal to and/or from one or more housings and/or alter a display of an image upon receipt of a signal. There may also be a remote control module in communication with the transceiver module and may be configured to transmit and/or receive a signal to and/or from the transceiver module. Additionally, there may be a signal converting module, in electrical communication with the transceiver module, and configured to alter a state of a signal transmitted and/or received by the transceiver module. The transceiver module may comprise an integrated circuit (IC) chip. The transceiver module may comprise an analog-to-digital signal converter.

In another embodiment, the remote control module may comprise a plurality of media content providers and/or a plurality of electronic communication devices. Each of the media content providers and/or electronic communication devices may be configured to selectably transmit image/media content and/or receive image/media content.

In still yet another embodiment, it may be that the product display system includes: a moisture sensing module in communication with least one of the group consisting of: the operating module, the activation module, the display module, and/or the audio module. The moisture sensing module may be configured to generate one or more images and/or sounds upon detection of moisture. The product display system may additionally include a temperature sensing module, in communication with at least one of the group consisting of: the operating module, the activation module, the display module, and/or the audio module. The temperature sensing module may be configured to generate one or more images and/or sounds whenever a predetermined critical temperature threshold is reached. The product display system may also include a wind sensing module, in communication with at least one of the group consisting of: the operating module, the activation module, the display module, and/or the audio module. The wind sensing module may be configured to generate one or more images and/or sounds when a predetermined critical wind speed threshold is reached.

In yet another embodiment, the product display system may include a reset module in communication with at least one of the group consisting of: the transceiver module and/or the operating module. The reset module may be configured to delete at least one of the first and/or second images displayed through the display module after a predetermined period of time lapsed wherein the transceiver module does not receive a signal.

It may be that one embodiment of the present invention includes a method of displaying images on a product, comprising the steps of: providing a product; coupling a product display system to a product; subscribing to at least one of a plurality of image content providers; receiving a wireless signal from an image content provider according to instructions; converting a wireless signal to an image and/or media content; storing an image and/or media content in the product display system; displaying an image and/or media content from the product display system; and/or deleting a displayed image and/or media content from the product display system according to instructions.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a container having a changing display according to one embodiment of the invention;

FIG. 2 is a block diagram illustrating a modular view of a container having a changing display according to one embodiment of the invention;

FIG. 3 illustrates a prior art sheet battery according to one embodiment of the invention;

FIG. 4 illustrates a prior art thin display according to one embodiment of the invention;

FIG. 5 illustrates a prior art solar cell according to one embodiment of the invention;

FIG. 6 is a network diagram of a product display system according to one embodiment of the invention;

FIG. 7 is a network diagram of a product display system according to one embodiment of the invention;

FIG. 8 is a network diagram of a product display system according to one embodiment of the invention;

FIG. 9 is a block diagram of a plurality of media content providers according to one embodiment of the invention;

FIG. 10 is a block diagram of a plurality of electronic communications devices according to one embodiment of the invention;

FIG. 11 is a network diagram of a product display system according to one embodiment of the invention;

FIG. 12 is a block diagram of a product display system according to one embodiment of the invention;

FIG. 13 is a perspective view of a product display system according to one embodiment of the invention;

FIG. 14 is a perspective view of a product display system according to one embodiment of the invention;

FIG. 15 is a network diagram of two product display systems in operation according to one embodiment of the invention; and

FIG. 16 is a flowchart diagram of a method of changing an image display on a product according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include: show data, participant data; sponsor data; financial institution data; media data, media metadata, and/or like data useful in the operation of the present invention. As those skilled in the art will appreciate, any computers discussed herein may include an operating system (e.g., Windows NT, 95/98/2000, Vista, OS2, UNIX, Linux, Solaris, MacOS, etc.) as well as various conventional support software and drivers typically associated with computers. In a non-limiting example, the computers may be in a home or business environment with access to a network. In an exemplary embodiment, access is through the Internet through a commercially-available web-browser software package.

As set forth in the specification, the system and method of the invention may facilitate the providing of information to recipients through multiple media sources and may allow the product display systems to receive information via similar multiple media sources. The multiple media sources may include, for example, chat room, radio, bulletin board, internet web pages, email, billboards, newsletters, commercials and/or the like. The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneider, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

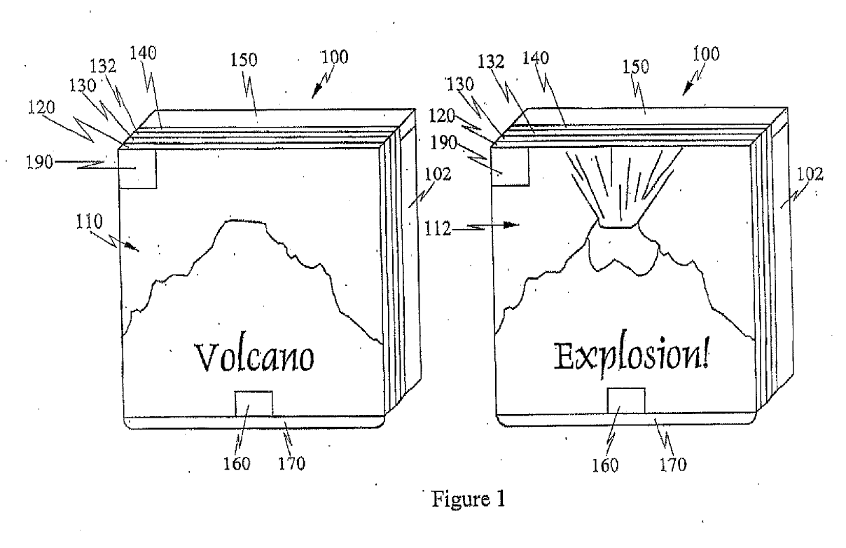

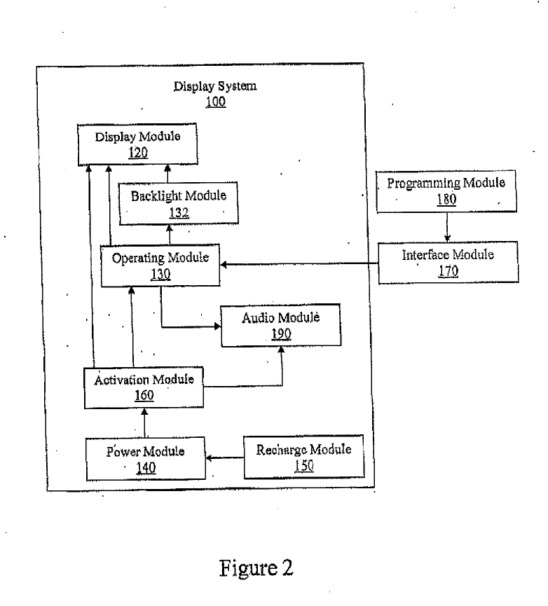

FIGS. 1 and 2 illustrate a product display system having a changing display according to one embodiment of the invention and a block diagram illustrating a modular view of a container having a changing display according to one embodiment of the invention, respectively. There is shown a container or product display system 100 having a first image 110 and a second image 112 each displayed on a display module 120. A container 100 may contain separate object(s) and or other content such as written materials. The display module 120 is coupled to an operating module or control module 130. The operating module 130 may include a processor or processor module, memory or memory module, and/or a transducer or transducer module.

In one non-limiting example a memory module may include an instruction set associated with an image and the processor module may direct the transducer module to alter the display module 120 according to the instruction set of the memory module thereby forming a desired image in the display module 120. Together, the operating module 130 and the display module 120 may be what is known in the art as electronic paper such as that described in U.S. Pat. No. 6,865,012 to Liang et al. and U.S. Pat. No. 6,914,713, issued to Chung et al., which patent specifications are incorporated by reference herein. Electronic paper may be generally described as a multiplicity of cells each including a fluid and one or more particles responsive to a stimulus such as a voltage or magnetic field. Typically, the particle includes a plurality of stable states including one wherein the particle is visible and one wherein the particle is not visible. Accordingly, a user may use a stimulus to alter the particle to one state or another wherein the particle may remain until otherwise stimulated. Therefore, a series of images may be generated by altering states of a plurality of particles. In some examples, electronic paper may include a plurality of colors, may be flexible, may present a non-emissive image, and/or may display an image without continuously consuming power. Other examples of display modules include but are not limited to: LCD, CRT, and full color digital ink displays by Magink Display Technologies Ltd. of Mevasseret Zion, Israel.

The operating module 130 may include an instruction set and/or logic control such that the operating module 130 may cause images to change according to a defined pattern. In one non-limiting example, the operating module 130 may cause an increase in frequency of image changes a few seconds out of every minute, thereby increases in frequency drawing increased attention to the product display system 100 during such time.

There is also shown a backlight module 132 that may be configured to emit light through the display module 120 and/or operating module 130. The backlight module 132 may include parameters that may be variable such as but not limited to brightness, color, and strobe frequency. The backlight module 132 may be configured to not shine through the display module 120 and/or operating module 130 but to instead provide a glowing border thereabout, thereby advantageously attracting additional attention to the product display system 100.

The electronic paper 120 and 130 or display module 120 and operating module 130 is shown electronically coupled to a power source or power module 140 such as but not limited to a thin film sheet battery, a button type battery, a power supply, a DC power source, an AC power source, and/or any combination thereof. A power module 140 may include one or more power sources such as but not limited to batteries. In another non-limiting example a power module is a solar cell. It is preferred that the power module 140 be coupled at least indirectly to the housing or coupling device 102. An example of such a battery may be found in U.S. Pat. No. 6,608,464, issued to Lew at al., the specification of which is incorporated by reference herein. The power source 140 is coupled to a product or product housing 102 such as but not limited to a CD/DVD case, a book, a greeting card, a billboard, a cereal box, a sign, and a toy/game carton/box. The power module 140 may include a power indicator such as a battery level indicator such as those sold under the name SAA1501T by Phillips Electronics having an office located at Groenewoudseweg 1, 5621 BA, Eindhoven in the Netherlands. A power indicator may be a thin strip coupled to a surface of a product and/or a surface of a product display system 100.

There is also shown a recharging module 150 coupled to the housing 102 and the power source 140. The recharging module 150 is configured to provide power to or recharge the power module 140. In one non-limiting example, the recharging module 150 is a thin solar panel or photovoltaic thin-film cell configured to provide a source of power to the power module 140 such as by recharging a battery in the power module 140. A non-limiting example of a photovoltaic thin-film cell includes the photovoltaic thin-film cell disclosed in US Patent Application Publication No. 2005/0183768, by Roscheisen et al., the specification of which is incorporated by reference herein.

Disposed on a front of the container 100 is shown an activation module 160. An activation module 160 may include a sensor such as but not limited to a light detector, motion detector, or pressure detector coupled to one or more of the display module 120, operation module 130, and power module 140 in such a way as to regulate power consumption from the power module 140. The activation module 160 may be in communication with the operation module 130 and/or may trigger or toggle one or more changes in the visual display 120 including but not limited to changing an image and changing a frequency of display of images. In one non-limiting example, the activation module 160 may be a light sensor that may restrict power flow from the power module 140 when light is not detected and/or only detected below a defined threshold. Accordingly, when a product may be being shipped, stored, or may not be prominently displayed, power is not consumed. In another non-limiting example, an activation module may restrict power from being drawn from the power module 140 until an action is performed, such as but not limited to removing a piece of tape from the activation module 160.

In another non-limiting example, the activation module 160 may include a pressure sensor, such as but not limited to contact points, a button, or squeeze actuatable switch or toggle. Accordingly, in one non-limiting example, a viewer may be presented with a visual display that may increase in activity when a “squeeze-me” button is actuated. Actuation of such may cause a display module to change one or more images and may cause images to change a plurality of times over a period of time. In another example, actuation of the activation module 160 may cause the audio module 190 to emit or not to emit a sound. Such may also include wherein the visual display may change images at a first frequency and actuation of the activation module 160 may cause the visual display to change images at a second frequency. In one non-limiting example the second frequency is greater (more rapid) than the first frequency. In another example, there may be a flap, such as but not limited to the front panel of a greeting card, wherein opening of the flap may actuate the activation module 160 and may result in one or more image changes as described above.

Therefore, a product display system 100 may have a plurality of activity levels, such as but not limited to a storage level wherein images do not change and power is not substantially consumed, a display level wherein images change at a rate sufficient to attract attention, and an enhanced level wherein images change more quickly and/or previously un-displayed images may display upon actuation of a sensor in an activation module 160 by a viewer.

Also, coupled to the operating module 130 is shown an interface module or interface tab 170. The interface tab 170 is configured to enable an operator to interface with the operating module 130 through a programming module 180 to perform one or more tasks such as but not limited to programming, diagnostics, loading/clearing memory, and changing operating parameters. In one non-limiting example the interface tab 170 is a strip of material including conductive leads in electrical communication with the operating module 130. There may be a perforation along the interface tab 170 such that the interface tab 170 may be easily removed from the container 100. The interface tab 170 may be configured to mate with a programming module 180 that may be another device coupled to a computer for facilitating operator functions. An interface tab 170 may be configured to receive data from the internet, a console, a desktop computer, etc. Further, an interface tab 170 may be configured to receive information by a variety of file types such as but not limited to jpg, TIFF, GIF, drafting files, EPS, WAV, MP3, etc. Still further, an interface module 170 may be an I/O device that may permit interfacing the operating module by any means of communication, including but not limited to IR, RF, and electrical communication.

Also shown is an audio module 190 configured to emit audio data. The audio module 190 is shown on a front of the product display system 100 but may be disposed anywhere. Preferably the audio module 190 is disposed on the product display system 100 such that sound from the audio module is not substantially distorted and/or muted. In one non-limiting example, the audio module 190 is coupled to a top front of the display module 120. Additionally, according to one embodiment, the audio module may include a volume control module configured for a user to adjust the volume of media content sound being emitted therefrom. Further, the audio module may further include a “mute” button or switch that enables a user to selectably turn off the volume of media content sound therefrom. In another non-limiting example, audio module 190 may be in communication with the operation module 130, the power module 140, and/or the activation module 160. Accordingly, the audio module 190 may be controlled in ways similar to control of the display module 120 as described herein. In one non-limiting example, the audio module 190 includes memory for storing audio play instructions.

The display module 120 may include a protective member, such as a sleeve and/or protective coating. Such may be but is not limited to a sleeve coupled to the housing into which other components of the product display system 100 may be disposed. Examples of protective members include but are not limited to substantially transparent or translucent plastic sheets or laminates.

In operation of one embodiment of the invention, a user may couple a product display system 100 to a container such as by a pressure adhesive or may have a product display system 100 having a container attached. In one non-limiting example, a product display system may include an adhesive layer coupled to a module of the product display system 100, such as the power module 140, and may further include a release layer coupled to the adhesive layer such that the release layer may be removed, thereby exposing the adhesive layer which may then be disposed on a surface of a container, thereby coupling the product display system to the container. In another non-limiting example, the coupling device and/or adhesive layer may be disposed on a front surface of the display module 120 such that the display module 120 may be coupled to a surface, such as but not limited to being coupled to a glass pane.

The product display system 100 may be programmed with a first image 110 and a second image 112 to be displayed. An object or other content may be included in the product display system 100, such as but not limited to placing a particular DVD into the housing 102. The product display system 100 may be shipped to a vendor location, such as but not limited to a retailer, where the product display system 100 may be displayed and offered for sale packaged with the contents of the housing. The activation module 160 may be used to conserve power in the power module 140, for example by only enabling the display module to change between the first and the second images 110 and 112 in circumstances where the product display system 100 is at least partially viewable by a potential buyer.

There may be a plurality of display modules 120 coupled to a container. In one non-limiting example, there is a pair of display modules 120 each controlled by a single operating module 130. A display module 120 may only cover a small portion of a container. In another example, a display module 120 may substantially enclose, envelope, or contain a container. In a further example, a container may be a DVD case as is commonly known in the art. Additionally, the product display system may be slipped between a protective member on the DVD case, which may wrap around the container, thereby substantially covering a majority of the exposed surface of the closed container.

In a still further example, a product display system 100 may ensconce a product and/or a container, wherein the product/container is substantially covered and/or nestled within the product display system 100. In one non-limiting example, the product display system 100 may be configured as a bag. In a still yet further example, there may be a product that is a greeting card having an aperture through a front panel wherein a display member 120 may be coupled to the front of a back panel and may display through the aperture of the front panel. More, an activation module 160 may detect an opening of the greeting card and may cause a second image to be displayed and/or a series of images to be displayed.

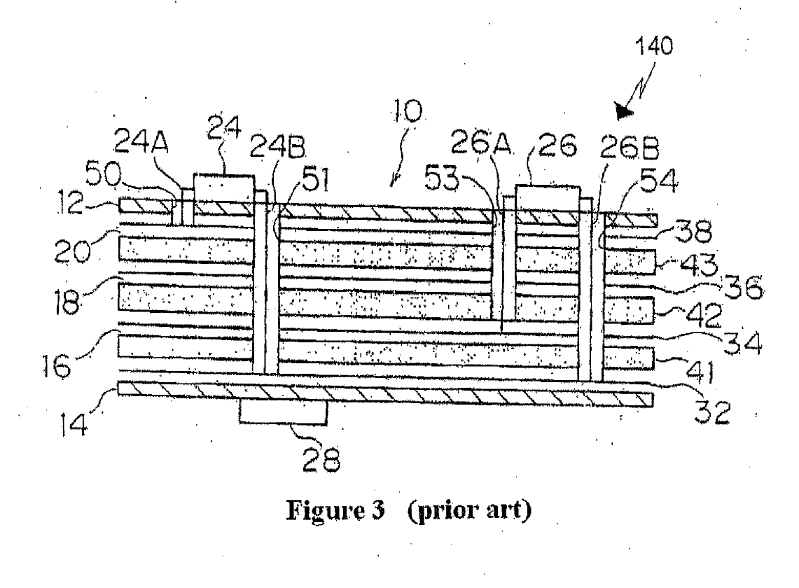

FIG. 3 illustrates a sheet battery 140 according to one embodiment of the invention. A layered substrate 10 in FIG. 3 has an upper substrate 12, a lower substrate 14, and three sheet batteries 16, 18, and 20 between the substrates 12 and 14. ICs 24 and 26 are disposed on the upper substrate 12 as electronic parts, and voltages of the ICs 24 and 26 are, for example, 5.0 V and 2.0 V, respectively. A reference number 28 is an IC which is disposed on the lower substrate 14.

In FIG. 3, the batteries 16, 18, and 20 are called, from the bottom to the top, the first sheet battery 16, the second sheet battery 18 and the third sheet battery 20. In this embodiment, the voltages of the first sheet battery 16, the second sheet battery 18, and the third sheet battery 20 are 2.0 V, 1.3 V, and 1.7 V, respectively, and the sheet batteries 16, 18, and 20 are connected in series.

The sheet batteries 16, 18, and 20 are disposed while being firmly contacted between the upper substrate 12 and the lower substrate 14. Reference numbers 32, 34, and 36 are electrode plates for the sheet batteries 16, 18, and 20, respectively, and reference numbers 41, 42, and 43 are battery media. The electrode plate 34 is used for both a cathode of the first sheet battery 16 as well as an anode of the second sheet battery 18, and the electrode plate 36 is used for both a cathode of the second sheet battery 18 as well as an anode of the third sheet battery 20.

On the layered substrate 10, holes 50 and 51 for power connect wires 24A and 24B of the IC 24, and holes 53 and 54 for power connect wires 26A and 26B of the IC 26 are formed. The hole 50 reaches a cathode plate 38 of the third sheet battery 20, whereas the hole 51 reaches an anode plate 32 of the first sheet battery 16. The power connect wire 24A is inserted through the hole 50 to the electrode plate 38. The power connect wire 24B is inserted through the hole 51 to the electrode plate 32. The voltage of 5.0 V is thereby supplied to the IC 24.

Now viewing the hole 53, it reaches the cathode plate 34 of the second sheet battery 18, whereas the hole 54 reaches the electrode plate 32 of the anode plate 32 of the first sheet battery 16. The power connect wire 26A of the IC 26 is inserted through the hole 53 to the electrode plate 34. The power connect wire 26B is inserted through the hole 54 to the electrode plate 32. The voltage of 2.0 V is thereby applied to the IC 26. Although not shown in the drawing, a hole reaches the cathode plate 34 of the second sheet battery 18 in a case that 3.3 V is required.

In the layered substrate 10 which is constructed as described above, the sheet batteries 16, 18, and 20 are sandwiched between the upper substrate 12 and the lower substrate 14 in layers, and thus the layered substrate 10 with a substrate and batteries integrated is constructed. Thus, the powers can be directly supplied from the sheet batteries 16, 18, and 20 to the substrates 12 and 14. In particular, the sheet batteries 16, 18, and 20 are connected in series and layered, and necessary electrode plates 32, 34, 36, and 38 are connectable via the holes 50, 51, 53, and 54; hence a plurality of voltages can be drawn corresponding with depths of the holes.

The sheet batteries 16, 18, and 20 of the layered substrate 10 can be so designed as to adjust capacity suitable for the respective loads. Because the sheet batteries 16, 18, and 20 are integrated as the layered substrate 10, exchanging of batteries is difficult; however, a secondary battery is used as a sheet battery and a charging circuit (not shown) may be provided within a device in which the layered substrate is incorporated. This makes the sheet batteries rechargeable, and the sheet batteries can be reused.

According to the present embodiment, the voltages for the substrates can be applied without a DC converter; consequently, the electronic device can be thinner and at the same time the circuit structure can be simplified.

In the above description, the three sheet batteries 16, 18, and 20 are presented, but the number of the sheet batteries is not limited to three, and it may be any if more than one. The voltages of the sheet batteries may be uniform, or may be different. In FIG. 3, the sheet batteries 16, 18, and 20 are sandwiched between the upper substrate 12 and the lower substrate 14, but either of the substrates 12 and 14 may be omitted.

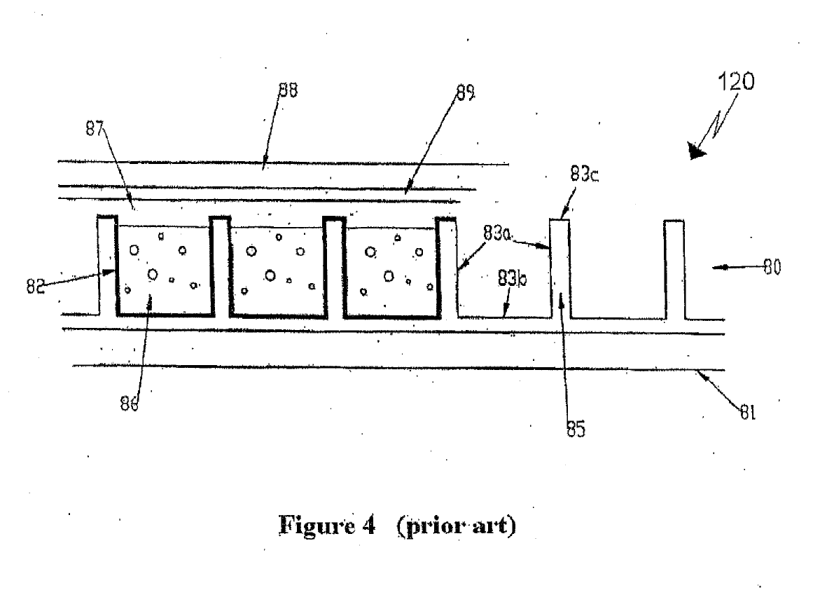

FIG. 4 illustrates a thin display 120 according to one embodiment of the invention. There is an electrophoretic display (EPD) that is a non-emissive device based on the electrophoresis phenomenon of charged pigment particles suspended in a solvent. Such a display usually comprises two plates with electrodes placed opposing each other, separated by using spacers. One of the electrodes, typically on the viewing side, is transparent. For the passive type of EPDs, row and column electrodes on the top (the viewing side) and bottom plates respectively are needed to drive the displays. In contrast, an array of thin film transistors (TFT) on the bottom plate and a common, non-patterned transparent conductor plate on the top viewing substrate are required for the active type EPDs. An electrophoretic fluid composed of a colored dielectric solvent with charged pigment particles dispersed therein is enclosed between the two electrodes.

When a voltage difference is imposed between the two electrodes, the pigment particles migrate by attraction to the plate of polarity opposite that of the pigment particles. Thus the color showing at the transparent plate, determined by selectively charging the plates, can be either the color of the solvent or the color of the pigment particles. Reversal of plate polarity will cause the particles to migrate back to the opposite plate, thereby reversing the color. Intermediate color density (or shades of gray) due to intermediate pigment density at the transparent plate may be obtained by controlling the plate charge through a range of voltages.

EPDs of different pixel or cell structures have been reported previously, for example, the partition-type EPD (M. A. Hopper and V. Novotny, IEEE Trans. Electr. Dev., 26(8):1148-1152 (1979)) and the microencapsulated EPD (U.S. Pat. Nos. 5,961,804, 5,930,026 and 6,017,584).

FIG. 4 illustrates an electrophoretic display prepared by an alternative process. In this process, an array of microcups (80) is formed directly on a first non-conducting substrate (81). Useful non-conducting substrates may include, but are not limited to, glass, metal sheets or films overcoated or laminated with a non-conducting or dielectric layer, and plastic films such as epoxy resins, polyimide, polysulfone, polyarylether, polycarbonate (PC), polyethylene terephthalate (PET), polyethylene terenaphthalate (PEN), poly(cyclic olefin) and composites thereof.

The microcups may be formed by any of the methods as described in Section I. After the formation of the microcups, a first conductor layer (82) is formed on the surface (83) of the microcups which includes the side surface (83a), the bottom surface (83b) and the top surface (83c) of the partition walls (85). In one embodiment, the first conductor layer may be formed on only the side surface (83a) and the bottom surface (83b). In another embodiment, the first conducting layer may be formed on the side surface (83a), bottom surface (83b) and the top surface (83c) of the partition walls and in this case the first conducting layer on the top surface (83c) of the partition walls may be later removed.

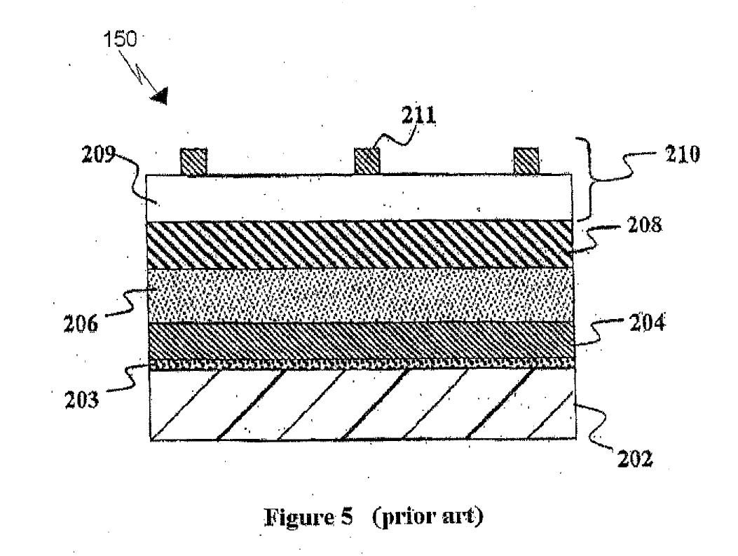

FIG. 5 illustrates a solar cell 150 according to one embodiment of the invention. An IB-IIIA-VIA alloy layer can be used in the active layer of photovoltaic cell. The solar cell 200 generally includes a substrate or base layer 202, a base electrode 204, a IB-IIIA-VIA layer 206, a window layer 208, and a transparent electrode 210. The base layer 202 may be made from a thin flexible material suitable for roll-to-roll processing. By way of example, the base layer may be made of a metal foil, such as titanium, a polymer such as polyimide or a metallized plastic. The base electrode 204 is made of an electrically conducive material. By way of example, the base electrode 204 may be a layer of stainless steel or molybdenum, e.g., about 0.5 microns to about 1 micron thick.

By way of example, and without limitation, the IB-IIIA-VIA layer 206 may include material of the general formula CuIn₁-xGaₓ(S or Se)₂. The IB-IIIA-VIA layer 206 may be fabricated by depositing a film of a molten mixture, e.g., roughly 1 to 10 microns thick on the base electrode 204. The film may be cooled to solidify the IB-IIIA-VIA layer 206. The IB-IIIA-VIA layer 206 may be about 1 micron to about 4 microns thick after cooling. By using a molten mixture of the type described above, the IB-IIIA-VIA layer 206 may be formed at a temperature compatible with the underlying substrate 202 and electrode 204. An optional adhesion layer 203 may facilitate bonding of the electrode 204 to the substrate 202.

After annealing, the film may optionally be exposed to selenium vapor at about 300-500 degrees C. for about 3045 minutes to ensure the proper stoichiometry of Se in the film. To carry out such a Se vapor exposure, the film, if deposited on a flexible substrate, can be wound into a coil and the coil can be coated so that the entire roll is exposed at the same time, substantially increasing the scalability of the Se vapor exposure process through such a high-volume batch process, e.g., as described above.

The window layer 208 is typically used as an interface between the band gaps of the different materials making up the IB-IIIA-VIA layer 206. By way of example, the window layer may include cadmium sulfide (CdS), zinc sulfide (ZnS), or zinc selenide (ZnSe) or some combination of two or more of these. Layers of these materials may be deposited, e.g., by chemical bath deposition, typically to a thickness of about 50 nm to about 100 nm.

The transparent electrode 210 may include a transparent conductive oxide layer 209, e.g., zinc oxide (ZnO) or aluminum doped zinc oxide (ZnO:Al), which can be deposited using any of a variety of means including but not limited to sputtering, evaporation, CBD, electroplating, CVD, PVD, ALD, and the like. If the substrate is flexible and the deposition technique is ALD or CBD or the like, a coiled/wound flexible substrate can be exposed so that the entire roll is processed at one time, e.g., as described above. The transparent electrode 210 may further include a layer of metal (e.g., Ni, Al or Ag) fingers 211 to reduce the overall sheet resistance.

An optional encapsulant layer (not shown) provides environmental resistance, e.g., protection against exposure to water or air. The encapsulant may also absorb UV-light to protect the underlying layers. Examples of suitable encapsulant materials include one or more layers of polymers, such as tetrafluoroethylene-hexafluoropropylene-vinylidenflouri-de-copolymer (THV), polyethylene terephthalate (PET), ethylene vinyl acetate (EVA), and/or Mylar®. Mylar is a registered trademark of E. I. du Pont de Nemours and Company of Wilmington, Del. Inorganic materials, such as glass and plastic foils, metalized plastic foils, and metal foils may also be used for the encapsulant layer. The encapsulant layer may also include nitrides, oxides, oxynitrides or other inorganic materials. Alternatively, the encapsulants may include Tefzel® (DuPont), tefdel, thermoplastics, polyimides, polyamides, nanolaminate composites of plastics and glasses (e.g. barrier films), and combinations of the above. For example, a thin layer of (relatively expensive) EVA/polyimide can be laminated to thick layer of (much less expensive) PET.

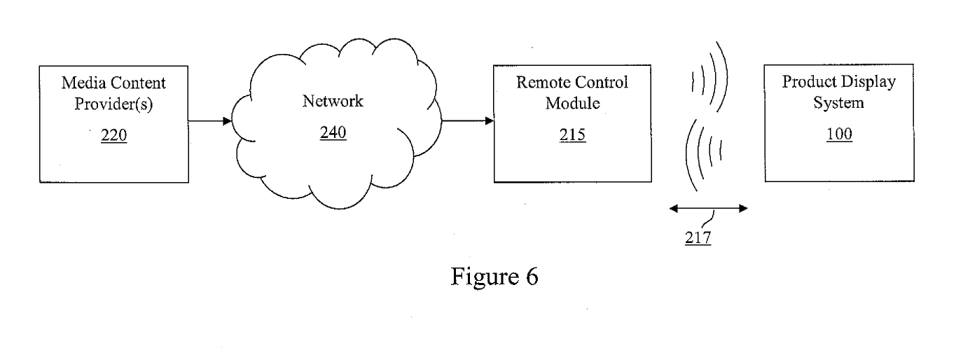

FIG. 6 illustrates an embodiment of one or more media content providers 220 in wireless communications with a remote control module 215 and a product display system 100. As shown, media content providers 220 (e.g., Movie/Video rental providers such as Blockbuster Video or Hollywood Video) may transmit media content through a wireless communications network 240 to a remote control module 215, such as an electronic communications device 230 (e.g., desktop computer, laptop computer, cell phone). In turn, the remote control module 215 may transmit and receive images and media content, in the form of wireless signals, to the product display system, as indicated by arrow 217. Some non-limiting examples of media content include, but are not limited to: photographs of people and objects, audio sounds, text messages, numeric messages, alphanumeric messages, music, video, etc. In turn, once the media content is received and stored in the electronic communications device, a user may manipulate the electronic communications device to transmit media content that may be displayed on the product display system; alter the display of media content displayed on the product display system and/or generate audio sounds from product display system's audio module 190 (e.g., radio/television speakers and/or headphones). One non-limiting example of a wireless communications network 240 is described in U.S. Pat. No. 7,209,474, issued to Acosta et al., which teachings are incorporated by reference herein.

Accordingly, according to one embodiment, a prospective client or customer may subscribe to at least one media content provider 220 for an agreed consideration. In addition, the media content provider may sell, distribute, or rent media content and products (e.g., DVDs, CDs, video cassettes) with product display systems 100 coupled thereto to their member customers. In turn, the media content provider may engage in consistent wireless communications with their clients possessing the product display systems. Advantageously, the media content provider and clients are enabled to establish a mutual relationship with each other through constant transmittal and receipt of messages through a wireless network without the clients and customers having to physically meet each other at the media content provider's brick and mortar location.

In operation of one embodiment of the invention, the product display system 100 may comprise movie DVDs/CD/video cassette containers with an electronic paper display module 120 entirely or partially coupled thereto. In instances where a client or customer rents the DVDs/videos from a movie/video provider he/she may receive spontaneous images in the form of advertisements such as “A new movie release is available for purchase within the next couple of days.” that may be suddenly displayed from the DVD/video case to alert a user desiring to rental the new release movie or video to consider renting such prior to other people renting it. The movie/video provider may also send a message as “Movie is overdue for return.”

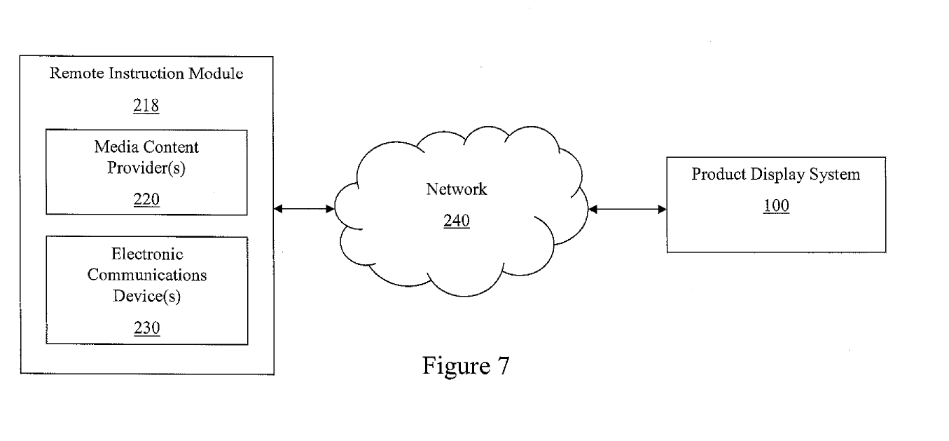

FIG. 7 illustrates an embodiment of a product display system according to one embodiment of the invention. As shown, there is remote instruction module 218, such as a media content service provider, providing media or images to a subscriber, such as from a base station, for example. Another non-limiting example of a remote instruction module 218 is described in U.S. Patent Publication Application No: 2006/0206580, by Oliver Johnson, which teachings are incorporated by reference herein. The remote instruction module 218 is in wireless communications with the product display system 100 through the wireless communications network 240. As shown, the remote instruction module may comprise one or more media content providers 220, such as Book Providers (e.g., Libraries) and one or more electronic communications devices 230 (e.g., cell phones, PDAs). The remote instruction module is configured to transmit multi-media content (interchangeably referred to as media content) to the product display system 100 in accordance to instructions. These instructions may comprise the transmittal of media content according to time of day, time of month, product return dates, new media subscriptions, etc.

In operation of one embodiment, a user possessing a product display system 100 coupled to a container, such as a car headrest or book bag may subscribe to a media content provider such as MTV® or CMT® for a variety of music media. In one embodiment, upon a request from a subscriber for a particular video from a favorite music artist, the media provider may employ a remote instruction module 218 (e.g., a Base Station Communications Technology controlled by an organization such as but not limited to MTV®) to wirelessly transmit requested video and/or music via a wireless communications network 240 to a product display system 100 that may be disposed in the subscriber's automobile or residence. Advantageously, this enables the subscriber to enjoy watching the video and listen to the music through the product display system 100 and audio module 190 on-demand from various locations.

In another embodiment, the remote instruction module comprises at least one electronic communications device 230 in wireless communications with the product display system 100. As one non-limiting example, assuming a user possesses both a hand-held, electronic communication device (e.g., PDA, blackberry) and a product display system 100 on a his or her book bag, the user may manipulate the electronic communication device to wirelessly transmit and receive media content (e.g., email/text messages, photographs, images, video, sound) to his or her product display system such that the said media content may be displayed from the display module 120 from his or her book bag and be stored on the product display system.

In operation of another embodiment, the user may manipulate the electronic communications device 230 to turn off messages such as “Movie is due tomorrow.” displayed on a DVD/video cases that was sent by the movie/video provider. The user may also program the device to have the message appear again on a DVD/video case in 3 hour intervals as a reminder to return the movie or video DVD to the movie/video provider. In turn, a user may manipulate the electronic communications device to transmit media content in the form of a text message response to the movie/video provider, such as, “I desire to purchase a new release movie when it is available, please reserve it for me.” Such a message may be transmitted to the provider directly from the product display system or may be transmitted or retransmitted through another device, such as but not limited to a cell phone or PDA. Upon receipt of the message from the user, the movie/video provider may grant the user's request and transmit a message to the product display system associated with DVD/video case and/or the user's electronic communications device.

In another non-limiting example of operation of one embodiment, upon a user checking out a book for three weeks, library personnel may download media content, such as messages or reminders to return books, advertisements of new books in their catalogs, etc. from their electronic communications devices such as computers, to the book(s) with product display systems 100 coupled thereon. Then the library personnel may manipulate their computers to program and instruct messages to be displayed on the product display system after two weeks, reminding the user “The books are due for return in one week.” Advantageously, this affords the user sufficient time to return the book(s) and avoid paying late fees for returning book(s) late; or it allows the user to manipulate his or her cell phone to communicate with the product display system, thereby transmitting a message to the librarian requesting to check out the book(s) for an additional period of time without physically traveling distances to the library in order to check out the book again for an extended period of time.

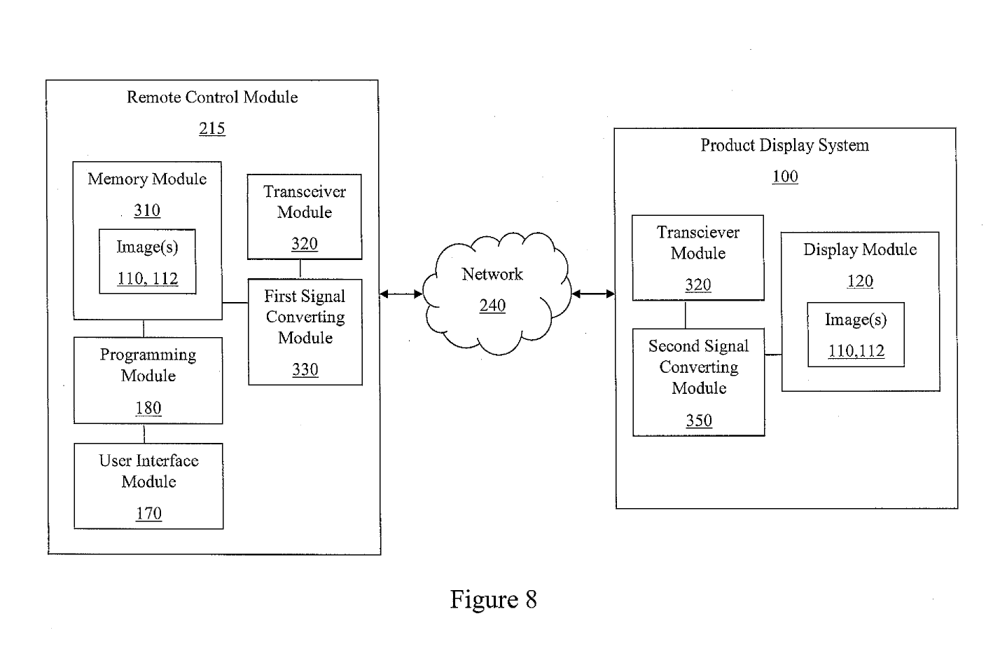

FIG. 8 illustrates one embodiment of a product display system 100. As shown, the system is in wireless communication with a remote control module 215 in the form of a portable electronic communications device 230, such as a PDA for example. In one embodiment, a remote control module may include a remote instruction module. It is contemplated in the art that the electronic communications device may or may not be a handheld wireless device. As shown, the remote control module and the product display system, each include a transceiver module 320 such as described in U.S. Patent Application Publication No: 2004/0184525, by Lee et al., which teachings are incorporated by reference herein. One skilled in the art would understand that the transceiver module is configured to transmit and receive image(s) 110, 112 and media content stored in the memory module 310 (e.g., primary storage unit such as a computer memory chip, second storage unit such as a hard diskette drive) in the form of analog or digital signals to/from other electronic communications devices. Also, as illustrated, the remote control module comprises a user interface module 170, such as a keypad, in electrical communication with a programming module 180, such as an integrated circuit (IC) chip, and configured to enable a user to manipulate and program the remote control module to alter an aspect of the product display system, such as but not limited to the appearance of image content displayed on the product display system.

According to one embodiment, FIG. 8 also illustrates a first signal converting module 330 disposed in the remote control module 215, in the form of a digital-to-analog signal converter, such as described in U.S. Pat. No. 6,314,020, issued to Hansen et al., which teachings are incorporated by reference herein. As shown, the first signal converting module is in communication with the transceiver module 320, and is configured to alter a state of a wireless signal processed therethrough. One skilled in the art would understand that such a converter may be adapted to process and convert image(s) 110, 112 in the form of discrete digital signals to real-world analog signals such that the image or media content may be transmitted by the transceiver module to the product display system 100 or other electronic communications device(s) 230 in a wireless communications network 240.

Additionally, as shown in FIG. 8, the product display system 100 further comprises a second signal converting module 350 (also referred to as a signal converter), such as an analog-to-digital signal converter described in U.S. Pat. No. 5,420,587, issued to Michel, which teachings are incorporated by reference herein. The signal converter is in electrical communication with the transceiver module 320 and is configured to alter a state of the signal received by the transceiver module. Once the signal is received and processed by the signal converter, one skilled in the art would understand that image or media content in the form of an analog signal may be converted to a digital signal that may be processed and displayed through the display module coupled to the product display system.

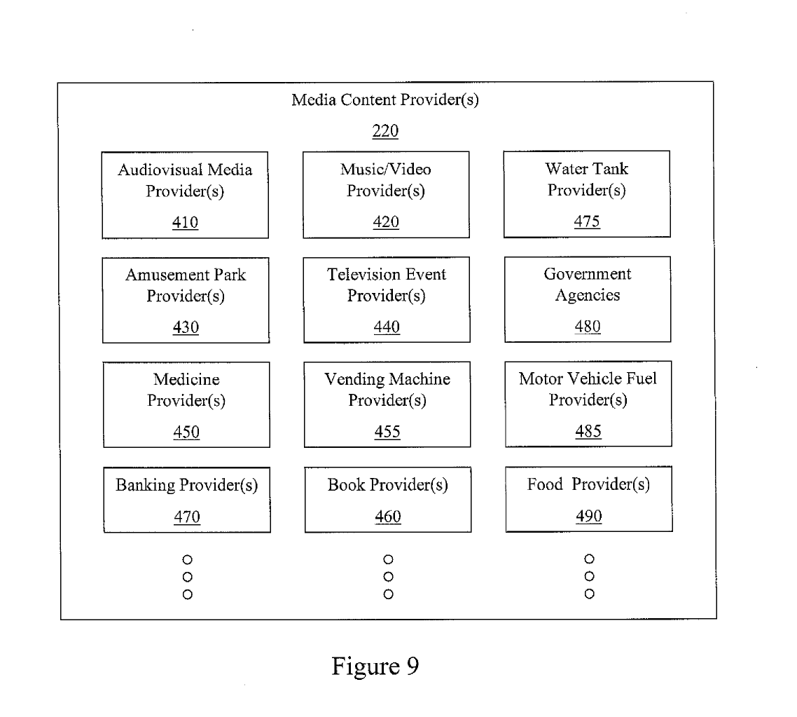

FIG. 9 is a block diagram illustrating non-limiting examples of image content providers. Names of the providers listed herein are trademarks of their respective owners. As shown, the image content providers include, but are not limited to: audiovisual media provider(s) 410 comprising Blockbuster Video Stores, Hollywood Video Stores, BestBuy, CompUSA, etc.; music media provider(s) 420 such as CompUSA, iTunes from Apple, etc.; amusement park provider(s) 430 comprising Disney World, Disneyland, Great Adventures, etc.; television event provider(s) 440 comprising Cox Communications, Comcast Cable Television, etc.; medicine provider(s) 450 comprising pharmaceutical establishments; vending machine provider(s) 455 such as Coca Cola, Inc.; banking provider(s) 470 comprising Wells Fargo Bank, Morgan Chase Bank, Bank of America, etc.; and book provider(s) 460 comprising Barnes and Noble, Borders, Religious Book Stores, Amazon, etc. One skilled in the art may understand that the above mentioned media content providers may selectably employ the electronic communication devices (e.g., computers, Internet, Kiosks) to transmit or receive media content, such as brand names, company trademark logos, advertisement information, etc. to the product display system 100.

In operation of one embodiment, an amusement or them park provider(s) 430, such as Disney World, may sell mugs with electronic paper coupled thereon to provide tourists with updated and animated media content, such as graphic pictures and/or messages concerning times and locations of events in the park displayed therefrom. According to various embodiments, other forms of media that may be displayed on the mugs include but are not limited to: video trailers presenting the movies may play such movies on the mug; the CEO of Disney may welcome visitors to the park; Tinker bell may appear on the mug reminding visitors that the park is closed and it is time to leave; advertisements and other messages/pictures may be displayed on the mug as a means to entertain tourists walking through the park.

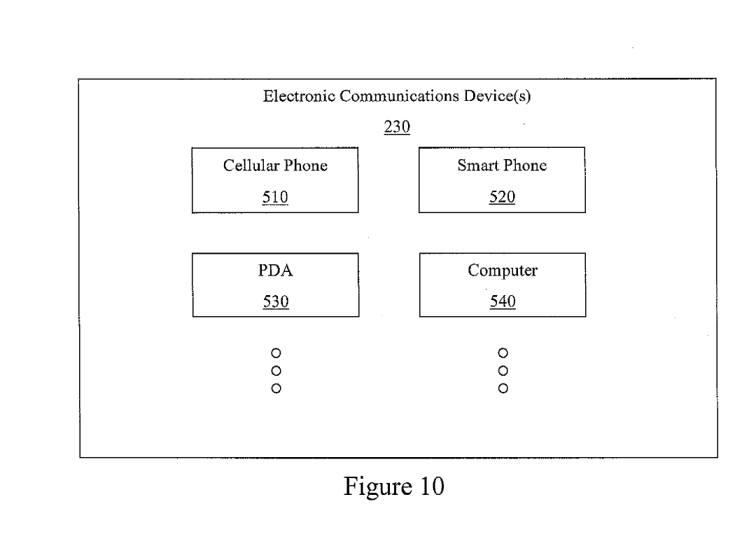

FIG. 10 illustrates non-limiting examples electronic communications devices 230. As shown, the devices may be employed to alter a state of the product display system 100. Additionally, as shown, the electronic communication device(s) include, but are not limited to: a cellular phone, such as a Nokia N91 Phone distributed by Nokia Corporation, P.O. Box 226, 00045 Nokia Group, Finland; a smart phone 520, such as a Cingular Wireless 8125 Smartphone distributed by Cingular Wireless Corporation, 5565 Glenridge Connector Atlanta, Ga. 30342; a personal digital assistant (PDA) 530, such as Samsung i730 PDA Phone distributed by Verizon Wireless Corporation, 15505 Sand Canyon Ave Irvine, Calif. 92618; and a computer 540, such as Dell Precision™ Desktop manufactured by Dell, Inc., 1 Dell Way Round Rock, Tex. US 78682. One skilled in the art would understand that a user may manipulate the electronic communications device(s) 230 to achieve remote communications with various electronic communications devices having a transceiver module 320 in a wireless communications network 240, thereby enabling a user to visually view and/or alter a state of the image(s) 110, 112 in the product display system.

In operation of one embodiment of the invention, a user traveling to various states within the U.S., or a foreign country, may purchase souvenirs with product display systems 100 coupled thereto. The user may employ an electronic communication device 230, such as a smart phone 520, to capture image(s) of the state's or country's scenery, as well as host family member(s) and friend(s). The user may manipulate the smart phone to transmit and receive selected image(s) 110, 112 and media content to the product display system. Advantageously, a user may customize the souvenir(s), thereby personalizing his or her travel experience and keeping the souvenir(s) with the device as a reminder of a memorable experience.

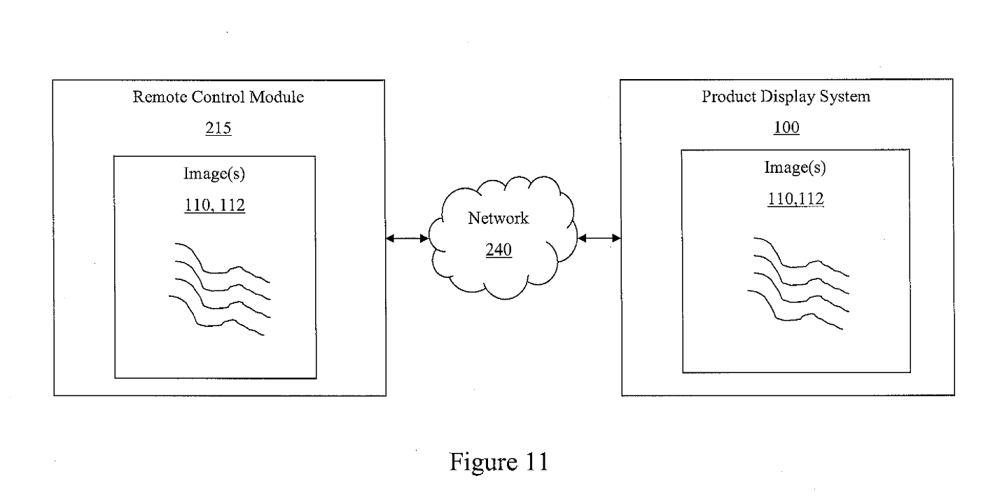

FIG. 11 is a perspective view of a product display system 100. As shown, image(s) 110, 112 may be stored and transmitted from the remote control module 215. Preferably, two-way wireless communication between the remote control module and the product display system 100 may occur. In one embodiment, a user may manipulate the remote control module to transmit images stored therein to the product display system. Likewise, a user possessing a remote control module may receive media content from the product display system.

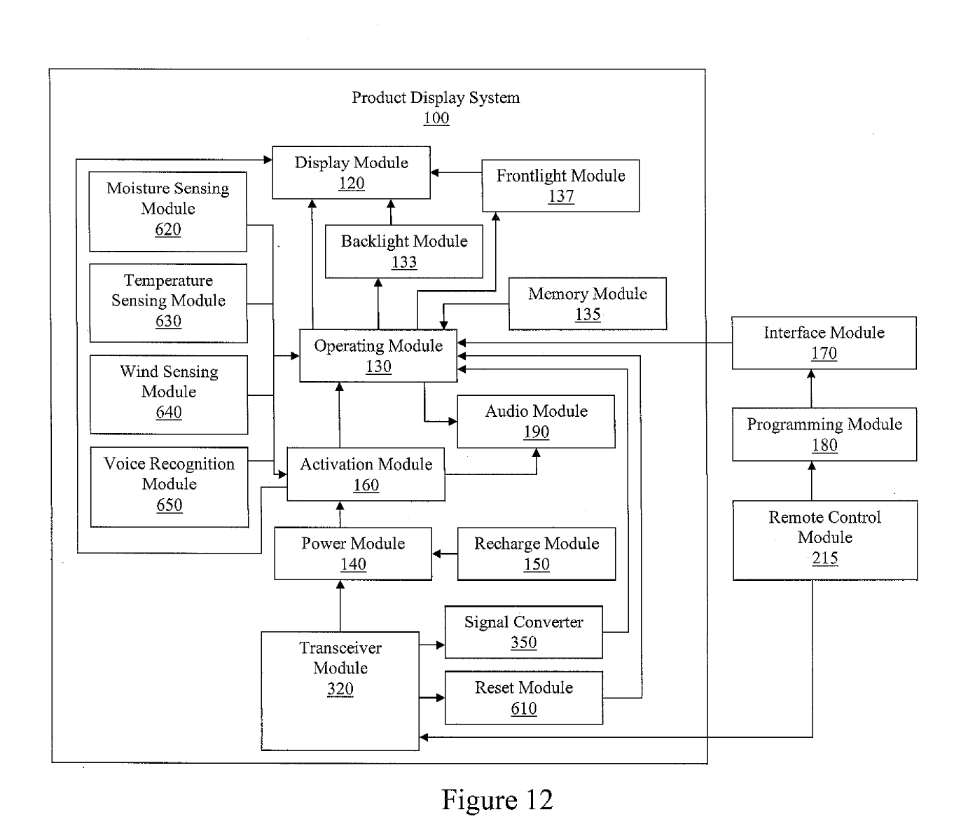

FIG. 12 is a modular view of a product display system 100. As shown, the system may further include a transceiver module 320, in electrical communication with a signal converter 350; a reset module 610, such as an electrical toggle or push button switch; and the remote control module 215 such as any electronic communications device 230 (e.g., blackberry, Bluetooth, PDA, electronic notepad) appreciated in the art. Additionally, in one embodiment, the remote control module 215 may be in electrical communication with the programming module 180, such as an IC chip, and may be configured to alter a state of the programming module, thereby enabling a user to employ the remote control module to program a time or time period where an image or media content may be processed by the operating module and subsequently displayed by the display module 120. More, the product display system includes a front light module 137 in electrical communication with the display module 120 and operating module 130, and configured to display light on the front of the display module. Advantageously, the front light module 137 enables a user to view images 110, 112 and media content from the display module, particularly during times when ambient light is not available, such as during hours of darkness or in a room or area void of sufficient lighting. Further, in one embodiment, the front light module 137 may be activated to emit light on the front of the display module 120 and operate independently from the backlight module 133.

According to one embodiment shown in FIG. 12, the reset module 610 is in electrical communication with the transceiver module 320 and the operating module 130, and is configured to instruct the operating module to erase images 110, 112 and other media content displayed by the display module 120. In one embodiment, the reset module may be a switch, or button, coupled to either an electronic communications device 230 and/or may be located at media content provider's location, thereby enabling a user to selectably erase images from the display module 120. In yet another embodiment, the reset module may comprise a sensor configured to automatically erase an image from the display module after a predetermined period of inactivity is sensed, such as when a wireless signal is not received by the transceiver module 320.

As shown in FIG. 12, the illustrated product display system 100 includes a moisture sensing module 620, such as described in U.S. Pat. No. 4,860,584, issued to Mercer et al., in which teachings are incorporated by reference herein. As shown, the moisture sensing module is in communication with at least one of the group consisting of: the operating module 130, the activation module 160, the display module 120, and/or the audio module 190. Additionally, the moisture sensing module is configured to generate an image, sound, and other media content upon detection of moisture on a product. In operation of one embodiment, a product display system may be coupled to a product, such as an infant's or elderly person's diaper. When the moisture sensing module senses moisture from human waste or other liquids residing on the diaper, the moisture sensing module activates the display module 120 to display a non-limiting example of a text image, such as, “The diaper is wet and may need to be changed,” while the audio module 190 communicates the same message. Advantageously, a child or adult care provider is alerted to the wet diaper, thereby reminding him or her to change the infant's or elderly person's diaper in a timely manner. This may prevent the infant's or elderly person's body parts in close proximity to the wet diaper from developing rashes or the like from prolonged exposure to moisture on his or her body.

In operation of one embodiment, a product display system 100 may be coupled to appliance products (e.g., refrigerator, water heater, washing machine) such that the moisture sensing module 620 may sense standing water accumulation in close proximity to said appliance products. The product display system generates an image display from a display module 120 and sound from an audio module 190 to warn a homeowner of such water accumulation that may cause potential electrical hazards, damage to said appliance products, etc. Further, the product display system alerts a remote instruction module of the condition, such that a home owner away from home may still be alerted to the problem. Advantageously, this allows the homeowner to take necessary action to remove water accumulation.

Further, as shown in FIG. 12, the illustrated product display system 100 includes a temperature sensing module 630, such as described in U.S. Pat. No. 5,499,024, issued to Germanton et al., in which teachings are incorporated by reference herein. As shown, the temperature sensing module is in electrical communications with at least one of the group consisting of the operating module 130, the activation module 160, the display module 120, and the audio module 190. The temperature sensing module is adapted to generate an image and/or sound when a predetermined critical temperature threshold is reached. For example, in operation of one embodiment, the product display system may be coupled to a product, such as a highway or road sign, and may coincidently display a flashing text message, such as, “Bridge could be ICY!!” and communicate the same message through the audio module 190 when the temperature sensing module 630 senses ambient air temperatures below a critical temperature threshold, such as freezing temperature level (e.g., zero degrees Celsius, thirty two degrees Fahrenheit). Advantageously, this draws the driver's attention to the product display system, thereby warning him or her of dangerous road conditions. This affords the driver an opportunity to avoid potentially slippery roads and significantly reduce the probability of accidents or injury to automobile drivers, passengers, and pedestrians.

In operation according to one embodiment, the illustrated product display system includes a temperature sensing module 630 coupled to vending machines supporting bottled drinks, ice cream, etc., wherein critical temperatures must be maintained to keep the drinks, ice cream, etc. cold. It is envisioned the product display system may emit/display an audio text and/or graphical message to a user in the event that the vending machine's temperature rises above a critical threshold, thereby warning the user to take action to repair the vending machine and/or remove the bottled drinks, ice cream, etc. to another vending machine or cooling device.

Additionally, as shown in FIG. 12, the illustrated product display system 100 includes a wind sensing module 640, such as described in U.S. Patent Application Publication No. 2007/0046480, by Stein, in which teachings are incorporated by reference herein. As shown, the wind sensing module, is in electrical communications with at least one of the group consisting of: the operating module 130, the activation module 160, the display module 120, and the audio module 190, and may be configured to generate an image and/or sound when a predetermined critical wind speed threshold is reached. For example, in operation of one embodiment, the product display system 100 may display a high wind speed warning message and associated sound effects whenever the wind sensing module senses high wind speeds associated with inclement weather conditions (e.g., tornadoes, hurricanes, thunderstorms, canyon winds, etc.). Advantageously, the product display system gives people advanced notice of inclement weather conditions and affords them time to secure their belongings and themselves into appropriate shelters or safe havens.

In still yet a further embodiment illustrated in FIG. 12, the illustrated product display system 100 includes a voice recognition module (voice sensing module, sound recognition/sensing module) 650, such as described in U.S. Patent Application Publication No: 2005/0288922, by Kooiman, which teachings are incorporated by reference herein. The voice sensing module is configured to transmit and/or receive images and other media content whenever the voice recognition module (also referred to as voice sensing module) recognizes or senses a human voice or sound in close proximity to the product display system. In one non-limiting example, there may be a product display system 100 coupled to a refrigerator, wherein the product display system may display a morning news program display; and/or turn a page of a downloaded newspaper or magazine, etc. Such may be triggered by a voice command. Advantageously, this enables a user to watch the news program or read the newspaper simultaneously while engaging in other activities without having to manually turn television channels or flip through pages of the newspaper.

Another non-limiting example of a product display system 100 having the voice recognition module 650 enables the product display system to emit a sound from the audio module 190 and/or display a message from the display module 650, such as a warning to a homeowner if a window or some other device coupled to the home is broken or that someone has entered the home. In another embodiment, a user may communicate his or her desired food or drink item to a vending machine having a product display system with the voice recognition module 650. Advantageously, this enables a user to retrieve his or her desired food or drink item without manually pushing any button.

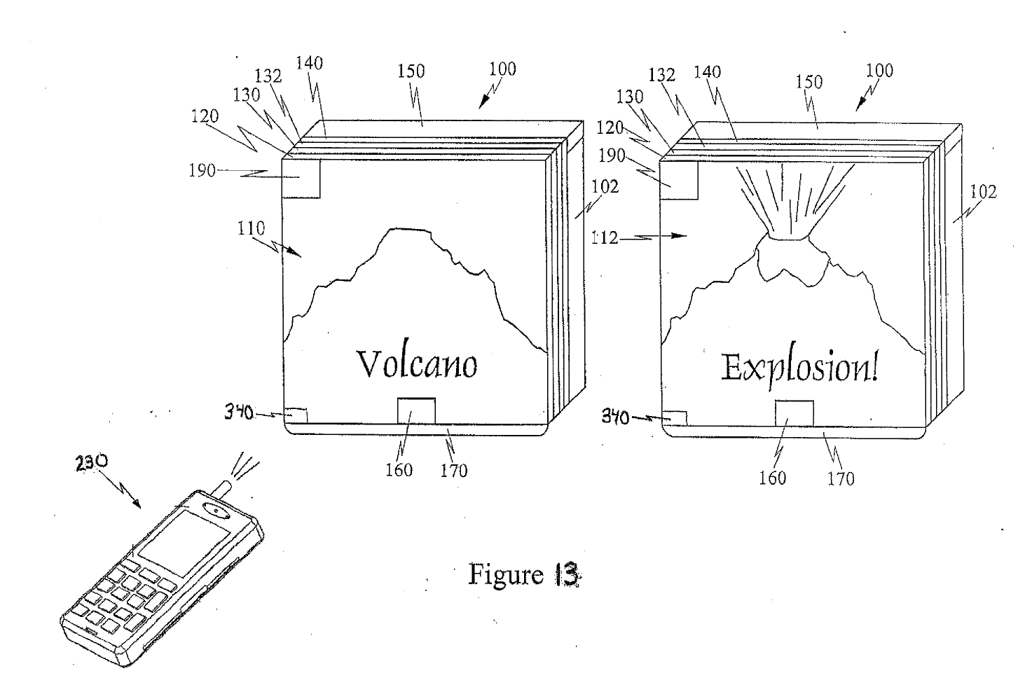

FIG. 13 is a perspective view of a product display system according to one embodiment of the invention. As shown, there is an electronic communications device 230, such as a cell phone, in wireless signal communications with the transceiver module 320 disposed on the product display system 100. This enables a user to manipulate the remote control module to generate a first image 110 on the display module 120. In addition, a user may manipulate the remote control module to alter an image display, thereby generating a second image 112 from the display module.

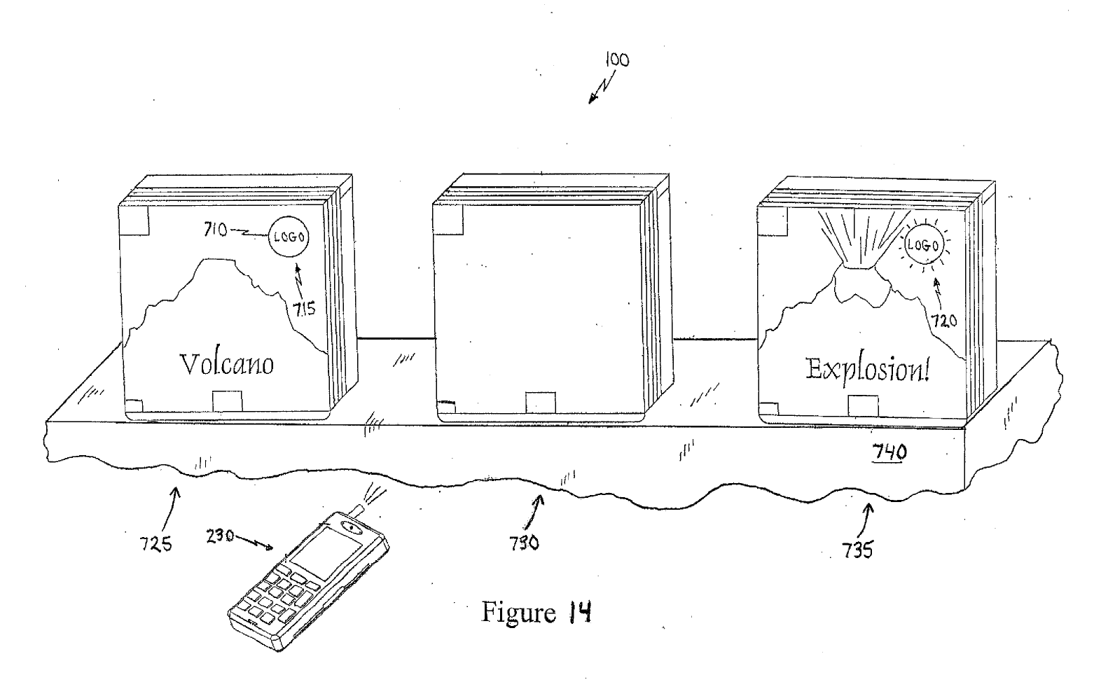

FIG. 14 is a perspective view of a product display system according to one embodiment of the invention. As shown, a user may manipulate the electronic communications device 230 to selectably generate image content 710 in a still mode 715 and/or flashing mode 720, independent of the first image 110 and the second image 112 so as to bring attention to the system from would be viewers. Additionally, according to one embodiment, a user may manipulate the electronic communications device 230 to erase an image from the display module 120. More, an image may be automatically deleted after a predetermined period of inactivity, such as a case where the transceiver module 320 does not receive a wireless signal.

Further, according to one embodiment shown in FIG. 14, a user may manipulate the remote control module 230 to selectably generate, or alter, a state of image contents 715, 720 independent of the first image 110 and the second image 112, or delete the images 110, 112 and image content 715, 720, such as business trademark logos, entirely from multiple product display systems 110 disposed at a plurality of different locations 725, 730, 735 on a surface 740 within a predetermined range of the electronic communications device 230. One non-limiting example of a surface 740 that the product display system(s) 100 may reside on includes, but is not limited to, a shelf or table that may be in a retail establishment. In other embodiments, the locations 725, 730, 735 may be geographically separated from each other such as three different retail establishments having the product display systems. In addition, the images 110, 112 and image content 715, 720, such as business trademark logos, may be automatically deleted after a predetermined period of inactivity, such as a case when the transceiver module 195 does not receive a wireless signal. Advantageously, this enables a retail establishment to showcase products and garner attention to the products from their customers.

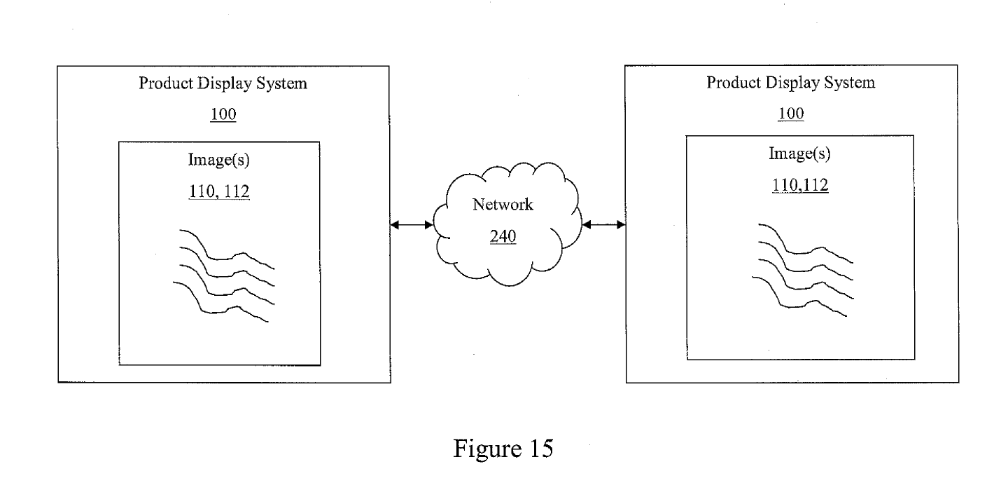

In yet another embodiment of the invention shown in FIG. 15, a first product display system 100 may be configured to transmit and receive images 110, 112 or other media content to and from a second product display system 100 in a wireless communications network 240. In one non-limiting example, a first product display system 100 having a moisture sensing module 620 may be coupled to a product, such as a bridge over-passing a road or highway, and a second product display system 100 may be coupled to a road sign at a distance from, but near the bridge. In operation of one embodiment, it is contemplated that when the first product display system senses excess water accumulation associated with the bridge, such as a result of a rain or snow storm for example, the first product display system may transmit a flashing text image, such as “Excess water over bridge, be careful,” to the second product display system such that said message may flash from the second product display system. Further, a product display system may emit sound on a detected condition, thereby providing an audible alarm. Advantageously, the warning would provide a person driving an automobile with sufficient notice to avoid possible water falling from the bridge; thereby preventing any person injury or accident.

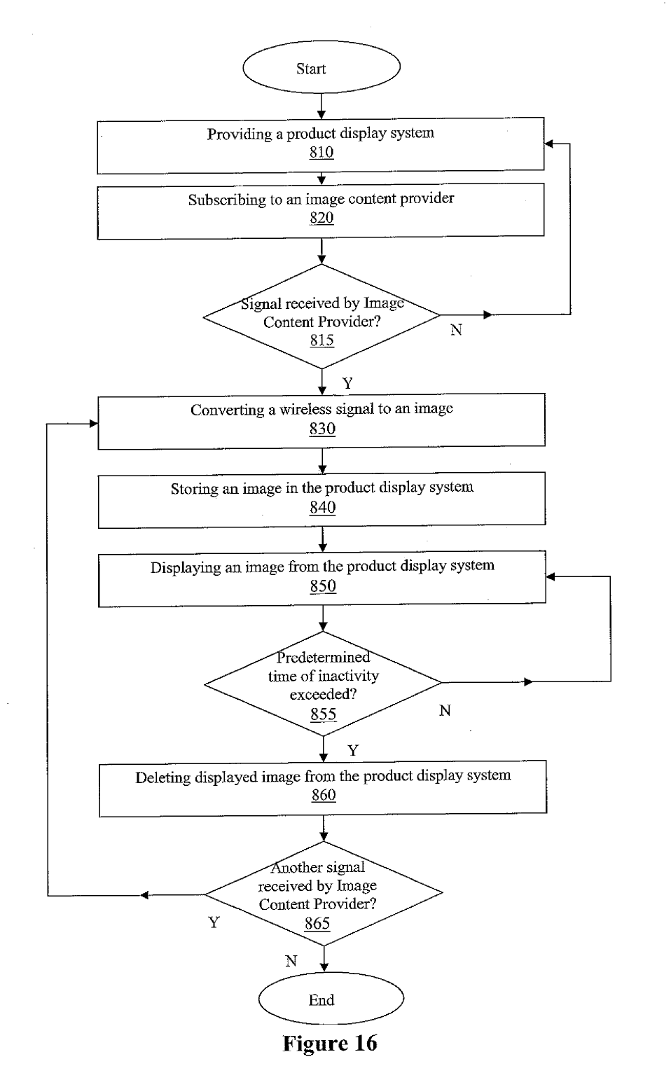

FIG. 16 is a flowchart diagram illustrating a method of changing an image display on a product. The illustrated method includes one or more of the steps of: providing 810 a product display system; coupling a product display system to a product; subscribing 820 to at least one image content provider; receiving 815 a wireless signal from an image content provider; converting 830 a wireless signal to an image; storing 840 an image in the product display system; displaying 850 an image from the product display system; determining 855 a time period of inactivity; updating 857 a displayed image from the product display system; and deleting 860 a displayed image from the product display system according to instructions, such as when a predetermined time of inactivity is exceeded in which the product display system does not receive a wireless signal. Further, one skilled in the art would envision that the present inventive method steps may be repeated if the product display system receives another wireless signal from an image content provider 220 or an electronic communications device 230 that is manipulated by a user. According to other embodiments, the method steps may further comprise: receiving an image from one or more product display systems; and transmitting an image to one or more product display systems.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, one skilled in the art would understand that the product display system 100 and its components may vary in shape, size, color, thickness, design, etc. according to various embodiments of the invention.

In addition, it is envisioned that the product display system 100 may transmit and/or receive images 110, 112 and other media content from media content service provider(s) 220, hand-held or desktop electronic communications devices 230, remote instruction modules 218, remote control modules 215, and/or other product display systems 100 in a wireless network 240, wherein wireless communications may be achieved through RF communications, satellite communications, broadband communications, microwave communications, infrared communications, etc.

It also envisioned that the electronic communication devices 230 employed to wirelessly communicate with the product display system 100 may further include, but is not limited to, Blackberries, Bluetooth devices, iPODs, one or more product display systems, satellites, routers, etc.

It is further envisioned that media content providers 220 may further include but are not limited to food service providers, military equipment providers, sporting goods providers, etc.

It is even further envisioned that both the remote control module 215 and the product display system 100 may further comprise a digital-to-analog signal converter.

Additionally, the product display system 100 may be coupled to sporting bags and other equipment, wherein sporting events may be displayed therefrom, thereby enabling people to watch one sport while engaging in another sport.

More, one skilled in the art would understand that the product display system 100 may be coupled to a multitude of products and still perform its intended function. Some non-limiting examples of such products include, but are not limited to mugs, purses, book bags, billboards, vending machines, water tanks, roadway signs, walls, tables, computers, etc.

Still more, embodiments of product display systems 100 may include a computer cable connection port (e.g., FireWire, USB) such that a user may employ a computer cable or the like to link product display systems 100 to portable, desktop, and/or mainframe computer systems to download and/or upload a plurality of images/media content (e.g., MTV®, CMT®, weather channel, television programs) to and from said computer systems and product display systems. It is envisioned that this may be accomplished through wireless means as well.

Further, it is envisioned that product display systems 100 may be coupled to advertising containers or products (e.g., vending machines, DVD cases, CD/CD-ROM cases) and may be time-synchronized nationwide, so that any nationwide advertising campaigns may start simultaneously while the containers are being used by the public.

Also, the product display system 100 may be coupled to medicine containers, and/or may wirelessly transmit and receive images and media content. For example, when a medicine prescription expires, the medicine prescription provider may transmit a notice to the product display system informing a user that it is time to purchase prescribed refills.

Moreover, the product display system 100 may be coupled to a computer system container, and/or transmit and receive media content such as messages notifying the owner of software/hardware updates as they become available for purchase.

Furthermore, the product display system 100 may be coupled to products, such as billboards, and/or may be configured to display updated messages and advertisements. Some non-limiting examples of messages that may be displayed may include tornado warnings, flood warnings, missing persons warnings, business advertisements, etc.

In addition, the product display system 100 may be coupled to a variety of containers, and/or transmit and receive email messages, images, etc. transmitted by electronic communications devices such as Blackberries. Advantageously, this enables people who don't own electronic communications devices to send and/or receive messages and images from friends and family without having to purchase electronic communications devices.

Also, the product display system 100 may be coupled to a variety of products in homes or offices and/or may include a chemical detecting module, such as described in U.S. Pat. No. 7,154,102, issued to Poteet et al., in which teachings are incorporated by reference herein. Further, it is contemplated that images 110, 112 and other media content may be displayed from the product display system 100 when the chemical detecting module detects various chemicals that may be hazardous to an occupant's health or well being. Some non-limiting examples of such chemicals, include but is not limited to: radon, carbon monoxide, smoke, etc.

More, the product display system 100 may be coupled to a variety of products in homes or offices and/or may include an electronic communications security module, such as described in U.S. Pat. No. 7,233,789, issued to Macor, which teachings are incorporated by reference herein. The electronic communications security module may be configured to restrict writeable access to images 110, 112 and other media content stored in the memory module 310 and/or displayed on the display module 120. Employment of the security module may thereby prevent a perpetrator from tampering with the images and media content or otherwise engaging in electronic vandalism or the like.

Still more, the product display system 100 may include a motion detecting module, such as described in U.S. Pat. No. 7,174,176, issued to Liu, in which its teachings are incorporated by reference herein. It is contemplated that the product display system may be activated and display images 110, 112 from the display module 120 and/or emit media content sounds from the audio module 190 whenever the motion detecting sensor or module senses motion from an individual/object approaching or otherwise moving in proximity to the product display system. In one non-limiting example, a product display system coupled to a vending machine may be activated when an individual approaches the machine to get food or drinks. In another non-limiting example, a product display system coupled to a road sign may be activated whenever a moving vehicle approaches the sign.

It is also envisioned that the product display system 100 may be coupled to a dashboard, visor, glove compartment or other surface of a vehicle. In the case of a vehicle owned by a car rental company, messages may be displayed and/or audible sounds may be emitted reminding car rental renters of a date and time when the rental car is to be returned. Further, the product display system may display images, messages, and other media content showing the drivers maps to help him or her find their way back to the rental car company such that the vehicle may be returned in a timely manner.

It is further envisioned that a user may employ an electronic communications device 230 to upload images and media content from the product display system 100 to a computer. For example, a user having a book bag with a product display system may employ an electronic communications device to download a video or image as desired from another individual's computer onto the book bag and/or upload the said video or image to his or her own computer from the book bag at a later time.

Additionally, it is envisioned that the power module 140 may comprise printable batteries that may be thin and/or may be employed with product display systems coupled to products having a short shelf life (e.g., cereal boxes).

Also, it is envisioned that the product display system 100 may be coupled to a wide variety of containers and/or products, and/or be configured to display messages, images, and other media content therefrom that are received from media content providers and/or electronic communications devices.

It is further envisioned that the product display system 100 may include an on/off switch, such as a push button switch, which may be electrically coupled thereto and/or may be configured to afford a user an option to manually activate and deactivate the product display system, thereby helping the system to conserve power.

It is expected that embodiments of product display systems may transmit and/or receive images, text messages, e-mail, video, and other media content to and from one or more product display systems with or without the aid of a hand-held electronic communications device 230 (e.g., remote control, cell phone, smart phone, etc.)

It is also expected that a user may employ an activation module, such as a “squeeze me” button to generate, update, change, and/or delete images and other media content that may be stored in the product display system's memory module. For example, a user may employ such a button to selectably view multiple images and displays from a product display system that may be coupled to a book bag, purse, etc.

Additionally, it is expected that a user may selectably adjust a volume of audio sounds and/or mute a sound that is emitted from the audio module 190 with or without the aid of hand-held electronic communications device(s) 230 (e.g., remote control) according to various embodiments.

More, it is expected that a user may selectably send and receive e-mail, images, media content, and other information to and/or from computer systems through hardware or wirelessly through wireless routers, Bluetooth, cell phones, smart phones, etc.

Further, it is expected that product display systems 100 coupled to containers and/or products (e.g., plastic mugs, purses, etc.) may transmit and/or receive images, media content, and advertisements in tandem from media content providers 220 in confined locations, such as a theme park, and/or in a multitude of locations nationwide.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A product display system, comprising:
a housing configured to contain a product;
a power module coupled to the housing and configured to provide electrical power;
a display module coupled to the housing, electrically coupled to the power module, and configured to visually display a first image and a second image;
an operating module in electrical communication with the display module and configured to control display of the first and second images;
a memory module in communication with the display module and configured to store information regarding the first and second images;
an activation module in electrical communication with at least one of the group consisting of the display module, the operating module, and the power module, wherein the activation module selectably restricts power consumption from the power module;
a transceiver module in communication with at least one of the group consisting of the power module, the activation module, the operating module, and the display module, wherein the transceiver module transmits and receives a signal to and from at least two housings and alters a display of an image upon receipt of a signal; and
a remote control module in communication with the transceiver module and configured to transmit a signal to the transceiver module, and receive a signal from the transceiver module.

2. The product display system of claim 1, wherein the activation module comprises a light sensor, wherein the activation module permits power consumption when light is detected by the light sensor and restricts power consumption when light is not detected by the light sensor.

3. The product display system of claim 1, further comprising a solar module electrically coupled to the power source and configured to provide power to the power module when exposed to a light source.

4. The product display system of claim 1, further comprising an interface module in communication with the operating module.

5. The product display system of claim 1, further comprising an audio module in electrical communication with at least the activation module and the operating module.

6. The product display system of claim 1, further comprising:
a moisture sensing module in communication with least one of the group consisting of the operating module, the activation module, the display module, and the audio module, and configured to generate an image and sound upon detection of moisture;
a temperature sensing module, in communication with at least one of the group consisting of the operating module, the activation module, the display module, and the audio module, and configured to generate an image and sound whenever a predetermined critical temperature threshold is reached; and
a wind sensing module, in communication with at least one of the group consisting of the operating module, the activation module, the display module, and the audio module, and configured to generate an image and sound whenever a predetermined critical wind speed threshold is reached.

7. The product display system of claim 1, wherein the housing comprises being substantially ensconced by the display module.

8. A product display system, comprising:
a container configured to house a separate object;
a power module configured to provide electrical power;
a display module coupled to the container in electrical communication with the power module and configured to selectably display visual information;
an operating module in communication with the display module and configured to control the display module;
a transceiver module in communication with the operating module, wherein the transceiver module receives signals and the operating module instructs the display module to alter a display of an image on the container upon receipt of a predetermined signal; and
a remote instruction module in communication with the transceiver module and configured selectably transmit the predetermined signal to the transceiver module.

9. The product system of claim 8, further comprising a signal converting module, in electrical communication with the transceiver module and the operating module, and configured to alter a state of a signal transmitted and received by the transceiver module.

10. The product system of claim 9, further comprising a reset module in communication with at least one of the group consisting of the transceiver module and the operating module, and configured to delete at least one of the first image and the second image displayed through the display module after a predetermined period of time lapsed wherein the transceiver module does not receive a signal.

11. The product display system of claim 8, wherein the container is selected from the group of containers consisting of clamshell cases, cups, vending machines, bags, boxes, and greeting cards.

12. The product display system of claim 8, further comprising a coupling device including:
an adhesive material coupled to the display module; and
a release layer coupled to the adhesive material and configured to be removed without substantially removing the adhesive material thereby exposing the adhesive material.

13. The product display system of claim 8, further comprising a light module coupled to the container and oriented towards the display module.

14. The product display system of claim 8, further comprising an interface module removably coupleable to the operating module and in communication therewith.

15. The product display system of claim 8, wherein the power module comprises a dry cell battery.

16. The product display system of claim 8, further comprising a recharging module in electrical communication with the power module and configured to supply power to the power module.

17. The product display system of claim 8, wherein the display module comprises electronic paper.

18. The product display system of claim 8, wherein the remote instruction module comprises a plurality of image content providers and electronic communication devices, wherein each are configured to selectably transmit image content thereto.

19. The product display system of claim 9, wherein the signal converting module comprises an analog-to-digital signal converter.

20. A method of displaying images on a product, comprising the steps of:
providing a product;
coupling a product display system the product;
subscribing to at least one of a plurality of image content providers;
receiving a wireless signal from an image content provider according to instructions;
converting a wireless signal to an image;
storing an image in the product display system;
displaying an image from the product display system;
updating a displayed image from the product display system; and
deleting a displayed image from the product display system according to instructions.
